(19) United States
(12) Patent Application Publication
(10) Pub. No.: US 2026/0273804 A1
(43) Pub. Date: Sep. 17, 2026

(54) SYSTEM AND METHOD FOR REUSE OF WASTE FIBERGLASS-COMPRISING COMPOSITE MATERIALS IN NEW PRODUCTS

(71) Applicant: Reba d.o.o., Gradac (SI)

(72) Inventor: Bojan Šegina, Gradac (SI)

(21) Appl. No.: 19/471,232

(22) PCT Filed: Mar. 31, 2023
(86) PCT No.: PCT/EP2023/058596

§ 371 Date: Sep. 30, 2025

(51) Int. Cl. B29B 17/04; B29K 67/00; B29K 105/00; B29K 105/26; B29K 309/08

(52) U.S. Cl. CPC B29B 17/0412; B29B 2017/0484; B29K 2067/00; B29K 2105/251; B29K 2105/26; B29K 2309/08

(57) ABSTRACT

A system and method enable reuse of waste fiberglass-comprising composite materials in new products. The system includes a grinding device for grinding the waste composite material, and an application device for applying the ground waste in a reuse process. The application second device includes
a container for ground waste material,
a mixing and dosing container for ensuring suitable dosing of the waste material,
a tube connected to an outlet of the mixing and dosing container, the tube having a diameter larger than the largest length of fiberglass fibres, wherein the spraying end of the tube is positioned at an angle from 40 to 60 degrees,
a second tube connected to a resin-filled container in order to lead fresh binding resin,
an under-pressure pump for allowing transport along the tube, and
a grounding cable for grounding all metallic parts of the device.

### CROSS REFERENCE TO RELATED APPLICATION

This present application is a § 371 national stage of International Application PCT/EP 2023/058596, filed Mar. 31, 2023, which is hereby incorporated herein by reference in its entirety.

### FIELD

The present invention belongs to the field of disposing solid waste, more precisely to the field of devices for transforming solid waste into something useful. The present invention relates to a system and a method for reuse of waste fiberglass-comprising composite materials, particularly polyester and fiberglass waste, in new products.

### BACKGROUND

Industries producing various products such as wind turbine blades, bathroom equipment, polyester boats, ultra-light aeroplanes, cisterns, truck cabins, and other components used in automotive industry have a problem with waste in the production process. The industries use composite materials, production of which increases every year. About 90% of the mentioned composite materials represent fiberglass reinforced plastics. Presently, the recycling of these composites is not achieved in a satisfying manner, mostly because the composite material following cross-linking cannot be remelted or remoulded or the fiberglass fibres are destroyed. Furthermore, the most common thermosetting resins, such as polyester and epoxy resin, cannot be depolymerised to their original constituents.

Consequently, most of the waste glass fibre composites are stored in landfills, burned or buried, thus representing an environmental issue and also an economical issue as such disposal can be very expensive.

Several technologies have been proposed for recycling thermoset composites. For example, some known solutions are intended for recovering inorganic fibres as described in patent applications WO2015011490, US20180230285, and EP2119741.The present invention does not recycle the composite materials by recovering only glass fibres, hence it differs from these solutions.

Patent application EP3216825A1 describes a method for recycling waste materials, preferably composite materials or glass from industrial waste, comprising steps of:
reducing waste material to powder by grinding;
preparing a suspension of a crosslinking agent in water;
possibly adding, to the suspension of point 2), the powder obtained at point 1) and a source of ions;
subjecting the mixture of point 3) to shaking up to formation of a hydrogel;
proceeding to freeze-drying of the hydrogel, obtaining a porous foam.

This differs from the present invention, as it does not use any hydrogel, freeze-drying or foam creation.

Patent application CA3154288A1 describes a method and apparatus for recovering fibres from fibre reinforced polymer (FRP) materials uses a thermomechanical process to produce high quality recovered fibres and powdered polymer resin. The thermo-(cryo-) mechanical process uses a combination of a selected range of temperatures and mechanical force, and is chemical and solvent-free, and produces zero waste. The method comprises a step of subjecting the FRP material to a selected temperature within a range of about −150° C. to about 350° C. Fibre length remains unchanged after processing and mechanical properties of the recovered fibres are comparable to or better than those of virgin fibres. The recovered fibres and powdered polymer resin may be used to make new FRP products.

Patent application WO2013164784A1 discloses a process of recycling a fibre-reinforced polymeric material comprising the following steps:
a) crushing the material so as to reduce it into fragments;
b) mixing the material obtained in the previous step with a liquid adhesive, the step b) being carried out by nebulizing the adhesive and simultaneously stirring the particles of the fibre-reinforced polymeric material so that a thin layer of adhesive is deposited on the surface substantially of each particle of fibre-reinforced polymeric material;
c) pouring the mixture obtained in step b) into a mould;
d) applying a pressure,
   wherein the first step a), it is provided a step a′) of grinding at least a portion of the fragments obtained in the step a) so as to obtain granules of dimensions between 2 and 8 mm, and subsequent to the step a′), it is provided a step a″) of pulverizing at least a portion of the granules obtained in step a′) so as to obtain particles of dimensions smaller than 1 mm.

This solution proposes a new step of moulding the recycled materials followed by applying pressure. The present invention, however, does not comprise re-moulding or any other similar step.

EP2878419A1 relates to a method of recycling scraps or offcuts of uncured composite material having reinforcing fibres and uncured polymer matrix material, comprising the steps of:
introducing the scraps or offcuts into a mixing device directly;
mixing the scraps or offcuts in the mixing device to blend uncured polymer matrix material and reinforcing fibres of the scraps or offcuts into a generally homogenous or consistent mixture; and
feeding or conveying the mixture from the mixing device into a shaping mechanism to form a component or semifinished product and preferably on a continuous basis.

This document also discloses a corresponding system for recycling scraps or offcuts of an uncured composite material. The system, further comprises a film applicator device configured to apply a film layer from a film roll to at least one side of the mixture fed or conveyed from the mixing device, wherein each film layer preferably forms a release film to assist removal of the component or product from the moulding tool.

All these solutions differ from the present invention, as it uses a different method of re-use or as it has a different application device.

### SUMMARY

A device and a method are provided for recycling or reuse of the composite materials, particularly polyester and fiberglass, in order to allow manufacturing of new products in a sustainable and cost-efficient manner.

A first aspect of the invention relates to a device for recycling composite materials, a second aspect to a method for recycling composite materials, and a third to products made from the recycled material using the device and/or the method.

The system according to the invention comprises two devices, wherein the first device is a grinding device for grinding the waste composite material to be processed and the second device is for application of the ground waste, i.e., for reuse of the processed waste.

The grinding device is arranged for grinding the composite waste material and comprises:
a first funnel or an inlet for loading and leading waste material towards a grinder,
the grinder for grinding the composite waste material coming from the funnel,
a sieve with openings having a maximum size of 4 mm for filtering ground resin particles larger than 4 mm, wherein the fiberglass fibres can pass through the openings due to their fibrous nature, i.e. small diameter,
optionally a cooling system arranged to cool the grinding device as due to waste resin in the composite waste material the mixture tends to heat, for preventing combustion of generated powder and particles during grinding,
a filter system, preferably an ATEX (atmosphere explosive) filter system, for preventing inhalation of created particles,
a second funnel or an outlet for leading the ground waste composite material into a suitable collector, container, waste bag or any other similar receptacle, preferably to a large waste bag,
a small dust particles waste container provided with suitable, preferably replaceable, filters, the small dust particles waste container.

In a preferred embodiment, the grinding machine may be a rebuilt hammer for wood grinding, wherein the rebuilding is considered presence of the above-mentioned sieve and the cooling system. The hammer applies force to provided waste and thus decreases the size of waste parts and particles.

The cooling system may be an external cooling system, such as a fan, a cooler or a similar device arranged to cool the grinding device by blowing cool air towards the grinding device. Cooling is preferred due to presence of resins, which may ignite during grinding. Alternatively, the cooling system may be internal, i.e., integrated in the grinding device as channels or any other suitable construction and may use any colling medium known to the skilled person.

Once the waste is ground, the container with collected waste is connected to the second, application device is for application of the ground waste, i.e., for reuse of the processed waste. The second device comprises at least the following components:
the container (hopper) with the collected waste material with a filter system for filtration to prevent contamination of environmental air,
a mixing and dosing container connected to the container with collected waste in any suitable manner, wherein the mixing and dosing container ensures suitable dosing of the waste material and is thus provided with:
   an outlet for leading material to a tube for spraying (application of ground waste material comprising fiberglass fibres),
   at least one sensor for material flow on the basis of which dosing of the waste material may be regulated, and
   an integrated mixing system (churn), preferably shaped as paddles, to prevent fiberglass hawing in front of the tube,
the tube connected to the outlet of the mixing and dosing container with a diameter larger than the largest length of fiberglass fibres to prevent hawing of fibres, usually the range of tube diameter is 20 to 50 mm, wherein the outlet of the tube is positioned at an angle from 40 to 60 degrees, which allows good and even waste and resin binding in the air before being sprayed onto a product.
a second tube connected to a resin-filled container in order to lead fresh binding resin from the resin-filled container to the exit of the tube for spraying waste fiberglass-comprising particles for re-use,
an under-pressure pump for allowing transport along to tube, wherein the pump comprises a tubular section with a first wider part on one end and a second wider part on the opposite end, wherein the angle of the sides of the first part to the tubular section is larger than the angle of the sides of the second part to the tubular section and wherein the wider parts are longer than 20 mm and preferably the second wider part is longer than the first wider part, and
a grounding cable for grounding all metallic parts of the device to a grounding line, because a static charge can build up quickly and cause fire or explosion.

The shape of the pump prevents hawing of the fiberglass-comprising waste material, hence good flow towards the exit of the tube is ensured. In a preferred embodiment, the under-pressure pump is made from stainless steel material to ensure longer operation as the fiberglass is aggressive for the material of the pump. The stainless steel may be heat treated for improved durability.

The principle of dosing is preferably based on injector blasting system, which is well-known to the person skilled in the art. Other dosing methods or equipment can be used to provide sufficient flow of the ground waste material to the tube for application of ground waste material.

The tubes are made from a material known to the person skilled in the art as suitable for use with fiberglass materials and resins.

The tube sprays the waste fiberglass-comprising material towards the product in the process of manufacturing, wherein the product is conveniently placed on a horizontal holder, a plate, or a table. The specific angle of the tube enables that less material goes to waste (i.e., more is sprayed on the product) and thus better waste re-use. When the fiberglass-comprising waste material and the fresh resin are mixed, a chemical reaction occurs and the combined material quickly solidifies as a layer on the product in the process of manufacturing.

Spraying reused waste into new products does not require new fiberglass, but only new binding resin, which reduces the need for new fiberglass fibres. The size of the fiberglass fibres may be adjusted in the process of grinding, hence different requirements may be met.

In a specifically preferred embodiment, a robot is used for all manipulation, as the resin and the fiberglass parts are dangerous for the operator's health.

As a second aspect of the invention, a method for reuse of waste fiberglass-comprising composite materials in new products comprises the following steps:
a) supplying waste fiberglass-comprising composite material to a grinding device,
b) grinding of waste material into smaller parts and particles in the grinding device,
c) leading the ground waste material into a mixing and dosing container, and optionally adjusting material flow through the mixing and dosing container,
d) leading ground waste material from the mixing and dosing container to a tube for spraying the fiberglass-comprising waste material onto a product in a manufacturing process, wherein a pump enables transport through the tube,
e) leading new binding resin via a second tube that is aligned with the tube for spraying the fiber-glass comprising waste material,
f) simultaneously spraying the binding resin and the fiberglass-comprising waste material to form a solid layer on the product.

The method may further comprise additional steps, such as:
g) optionally curing or hardening of the layer on the product, and/or
h) optionally repeating previous steps to make several layers on the product, and/or
i) optionally further processing of the product depending on its final use.

A third aspect of the invention relates to a product made from the material prepared by the system and/or the method according to the invention, wherein the product may be any product made in moulds and/or with added layers of composite materials comprising fiberglass. Typical examples are bathroom products, such as bath tubs. Further, sport boats, sailing boats, yachts, truck cabs, parts for vehicles such as spoilers, blades for wind turbines, sewer pipes and manholes, etc. are also possible. The invention enables safe, reliable, and cost-efficient procedure for recycling of composite material and manufacturing of an ecological product. At the same time, the consumption of new fibreglass is limited, as the recycled fibreglass is used in new products.

These and other objects, advantages, purposes and features of the present invention will become apparent upon review of the following specification in conjunction with the drawings.

### BRIEF DESCRIPTION OF THE DRAWINGS

The invention will be described in further detail based on exemplary embodiments and figures, which show:

FIG. 1 a grinding device according to a possible embodiment from two sides;

FIG. 2 an application device for application of the ground waste, i.e., for reuse of the processed waste according to a possible embodiment;

FIG. 3 a robotic arm with the tube for spraying fiberglass-comprising waste composite material and the tube for providing fresh binding resin; and

FIG. 4 the under-pressure pump body.

### DETAILED DESCRIPTION

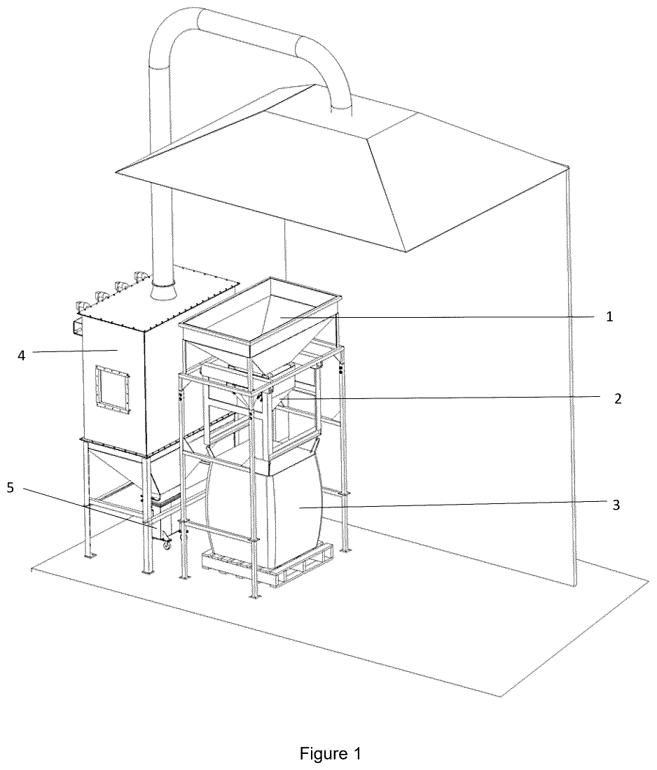

FIG. 1 shows a grinding device according to a possible embodiment, which is arranged for grinding the composite waste material. The grinding device comprises:
a first funnel 1 or an inlet for loading and leading waste material towards a grinder 2,
grinder 2 for grinding the composite waste material coming from the funnel 1,
a sieve (not visible) with openings having a maximum size of 4 mm for filtering ground resin particles larger than 4 mm, wherein the fiberglass fibres can pass through the openings due to their fibrous nature, i.e. small diameter,
a cooling system (not shown) arranged to cool the grinding device 2 as due to waste resin in the composite waste material the mixture tends to heat, for preventing combustion of generated powder and particles during grinding,
a filter system 4, preferably an ATEX (atmosphere explosive) filter system, for preventing inhalation of created particles,
a second funnel (not shown) or an outlet for leading the ground waste composite material into a suitable collector, container, waste bag or any other similar receptacle 3, preferably to a large waste bag,
a small dust particles waste container 5 provided with suitable, preferably replaceable, filters, the small dust particles waste container.

The cooling system is an external cooling system, such as a fan, a cooler or a similar device arranged to cool the grinding device by blowing cool air towards the grinding device.

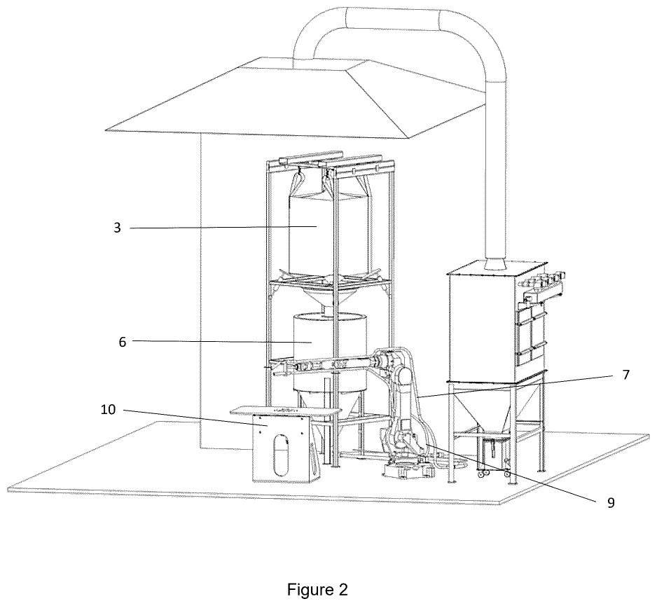

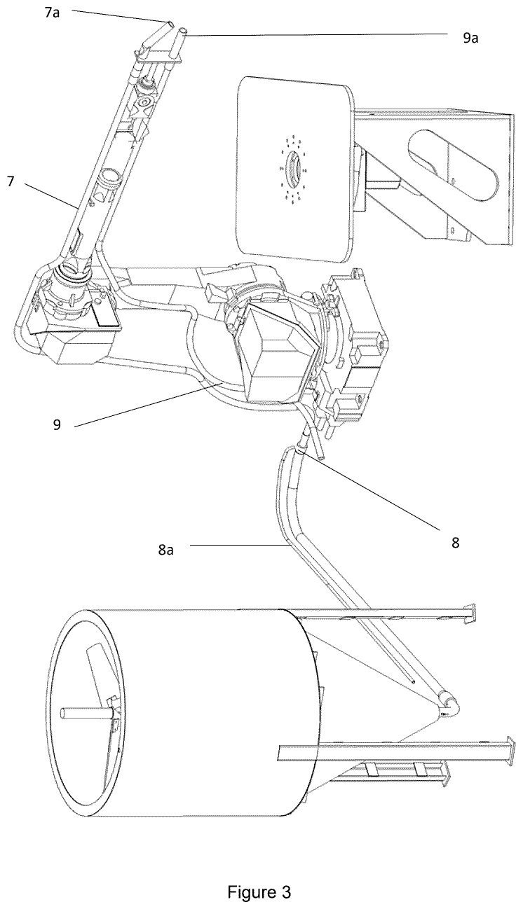

FIGS. 2 and 3 show the application device for application of the ground waste, i.e., for reuse of the processed waste according to a possible embodiment, which comprises at least the following components:
the container 3 (hopper) with the collected waste material with a filter system for filtration to prevent contamination of environmental air, which may be the same as in the grinding device or a different one, to which the ground material is transferred,
a mixing and dosing container 6 connected to the container with collected waste in any suitable manner, wherein the mixing and dosing container ensures suitable dosing of the waste material and is thus provided with:
   an outlet for leading material to a tube for spraying,
   at least one sensor for material flow on the basis of which dosing of the waste material may be regulated, and
   an integrated mixing system (churn), preferably shaped as paddles, to prevent fiberglass hawing in front of the tube,
the tube 7 for spraying fiberglass comprising waste material connected to the outlet of the mixing and dosing container 6 with a diameter larger than the largest length of fiberglass fibres to prevent hawing of fibres, usually the range of tube diameter is 20 to 50 mm, wherein the tube is positioned at an angle from 40 to 60 degrees, which allows good and even waste and resin binding in the air before being sprayed onto a product on a suitable support 10,
a second tube 9 connected to a resin-filled container (not shown) in order to lead fresh binding resin from the resin-filled container to the exit 9a of the tube for spraying waste fiberglass-comprising particles for re-use,
an under-pressure pump 8 (FIG. 3) provided between the mixing and dosing container and the outlet of the first tube for application of ground waste material, the pump being provided with an air compressor for providing compressed air and an air pipe connected to an inlet of the pump for leading air into the interior of the pump in order to achieve pump operation,
   wherein the pump comprises a tubular section with a first wider part on one end and a second wider part on the opposite end,
   wherein the angle of the sides of the first part to the tubular section is larger than the angle of the sides of the second part to the tubular section, and
   wherein the wider parts are longer than 20 mm and the second wider part is longer than the first wider part, and
a grounding cable (not shown) for grounding all metallic parts of the device to a grounding line, because a static charge can build up quickly and cause fire or explosion.

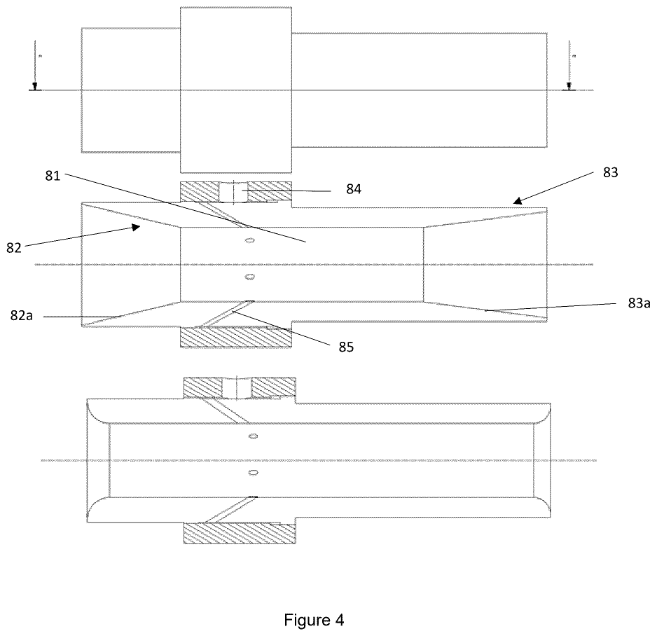

The preferred length of the tube 7 for spraying, i.e. application of ground fiberglass-comprising waste material is 2 to 8 m, most preferably 5 m, wherein the wall thickness of the tube is preferably between 6 and 10 mm, most preferably 7.5 mm, as this thickness provides optimal life-span of the tube. The fiberglass fibres are aggressive for the material, hence, the thickness is preferred. Furthermore, the under-pressure pump 8 may be provided at any location of the tube. The optimal positioning of the under-pressure pump is approximately in the middle of the tube as shown in FIG. 2. Other positions are nevertheless also possible and depend on the tube diameter, characteristics of the under-pressure pump and the length of the pipe. These adjustments are obvious to a skilled person. The diameter of the pipe of the under-pressure pump is usually smaller than the diameter of the tube. The pump operates in a known manner, wherein air 8a is connected directly to the inlet 84 of the pump 8 and through the holes on the inside of the pump further shaped as air channels 85 at an angle create flow. The flow ensures flow of the particles towards the outlet of the tube. The inlet and air channels are depicted in FIG. 4.

FIG. 3 shows an embodiment with a robotic arm provided with the tube for spraying fiberglass-comprising waste composite material and the second tube for providing binding resin. The second tube is connected to a suitable container with fresh resin, which is not shown in the figure. The under-pressure pump is visible in this figure.

FIG. 4 shows the under-pressure pump from outside (above), in the cross-section (middle) and in an original cross-section (below), which has been reshaped in order to achieve optimal operation. The under-pressure pump has:
the tubular section 81 with the first wider part 82 on one end and the second wider part 83 on the opposite end, wherein:
   the angle of the sides 82a of the first part 82 to the tubular section is larger than the angle of the sides 83a of the second part 83 to the tubular section 81, and
   the wider parts 82, 83 are longer than 20 mm and the second wider part 83 is longer than the first wider part 82.

The preferred inner diameter of the tubular section 81 is 12 mm, the angle of the sides 82 a of the first part 82 is 13 degrees and the angle of the sides 83 a of the second part 83 is 7 degrees.

Changes and modifications in the specifically described embodiments can be carried out without departing from the principles of the present invention which is intended to be limited only by the scope of the appended claims, as interpreted according to the principles of patent law including the doctrine of equivalents.

1. A system for reuse of waste fiberglass-comprising composite materials, said system comprising:
a grinding device for grinding the waste fiberglass-comprising composite materials to be re-used as processed composite material; and
an application device for applying the processed composite material;
wherein said grinding device and said application device are connected to lead the processed composite material from said grinding device to said application device;
said application device comprising:
a ground waste container for ground waste material, said ground waste container having a filter system for filtration to prevent contamination of environmental air;
a mixing and dosing container connected to said ground waste container with collected waste in any suitable manner, wherein said mixing and dosing container is operable to dose the processed composite material, and comprises:
an outlet for leading material to a first tube for spraying;
at least one sensor for material flow-on for regulating the dosing of the processed composite material and
an integrated mixing system;
said first tube connected to said outlet of said mixing and dosing container, wherein an outlet of said first tube is positioned at an angle from 40 to 60 degrees;
a second tube for coupling to a resin-filled container, said second tube configured to lead fresh binding resin from the resin-filled container to said outlet of said first tube for spraying waste fiberglass-comprising particles for re-use;
an under-pressure pump for directing the fiberglass fibres along the-said first tube, wherein said under-pressure pump comprises a tubular section with a first wider part on one end and a second wider part on an opposite end, wherein the angle of sides of said first wider part to said tubular section is larger than the angle of sides of said second wider part to said tubular section and wherein said first and second wider parts are longer than 20 mm; and
a grounding cable for grounding all metallic parts of said device to a grounding line.

2. The system according to claim 1, wherein the range of diameter of said first tube is 20 to 50 mm.

3. The system according to claim 1, wherein said under-pressure pump is shaped so that said second wider part is longer than said first wider part.

4. The system according to claim 1, wherein said under-pressure pump is shaped so an inner diameter of said tubular section is 12 mm, the angle of said sides of said first wider part is 13 degrees, and the angle of said sides of said second wider part is 7 degrees.

5. The system according to claim 1, wherein said under-pressure pump is made from stainless steel.

6. The system according to claim 5, wherein said stainless steel is heat treated for improved durability.

7. The system according to claim 1, wherein said under-pressure pump is in a middle region of said first tube for spraying fiberglass-comprising waste composite material.

8. The system according to claim 1, further comprising a robot arm provided with said first tube for spraying fiberglass-comprising waste composite material and said second tube for spraying the fresh binding resin.

9. The system according to claim 1, wherein said grinding device comprises:
a first funnel or an inlet for loading and leading waste material towards a grinder for grinding the waste fiberglass-comprising composite materials coming from the said first funnel;
a sieve with openings having a maximum size of 4 mm for filtering ground resin particles larger than 4 mm, wherein the fiberglass fibres can pass through said openings;
a filter system for preventing inhalation of created particles;
a second funnel or an outlet for leading the processed composite material into a receptacle;
a small dust particles waste container.

10. The system according to claim 9, further comprising a cooling system arranged to cool said grinding device.

11. The system according to claim 10, wherein said cooling system is an external cooling system or an integrated cooling system.

12. The system according to claim 11, wherein said cooling system is an external cooling system comprising a fan.

13. The system according to claim 9, further comprising a filter for said small dust particles waste container, and wherein said filter system comprises an atmosphere explosive (ATEX) filter system.

14. A method for reuse of waste fiberglass-comprising composite materials in new products, wherein said method comprises the following steps comprising:
supplying waste fiberglass-comprising composite material to a grinding device;
grinding the waste fiberglass-comprising composite material into smaller parts and particles in the grinding device to form a ground waste material;
leading the ground waste material into a mixing and dosing container;
leading the ground waste material from the mixing and dosing container to a first tube;
pumping the ground waste material through the first tube for spraying the ground waste material onto a product in a manufacturing process;
leading new binding resin via a second tube that is aligned with the first tube; and
simultaneously spraying the new binding resin and the ground waste material through the second tube and the first tube to form an uncured layer on the product.

15. The method according to claim 14, further comprising,
curing or hardening of the uncured layer on the product; and/or
repeating previous steps to make several layers on the product; and/or
further processing of the product.

16. The method according to claim 14, the waste fiberglass-comprising composite material is a polyester-fiberglass material.

17. (canceled)

18. (canceled)

19. (canceled)
